(19) United States
(12) Patent Application Publication
(10) Pub. No.: US 2024/0259197 A1
(43) Pub. Date: Aug. 1, 2024

(54) KEY ROTATION BASED ON TRAFFIC STATE

(71) Applicant: Red Hat, Inc., Raleigh, NC (US)

(72) Inventors: Andrea Cosentino, Rome (IT); Paolo Antinori, Novara (IT)

(21) Appl. No.: 18/160,504

(22) Filed: Jan. 27, 2023

(51) Int. Cl. H04L 9/08; H04L 9/32

(52) U.S. Cl. CPC H04L 9/0891; H04L 9/0872; H04L 9/3297

(57) ABSTRACT

A method of updating an encryption key used by a vehicle to encrypt data includes detecting a first location of the vehicle, detecting a state of vehicular traffic in a first area encompassing the first location of the vehicle, and sending a first request to a remote computing device to update the encryption key, wherein the first request is sent based at least in part on the state of the vehicular traffic in the first area.

### TECHNICAL FIELD

Aspects of the present disclosure relate to data encryption and secure communication between computing devices and, more particularly, to determining a timing for the rotation of an encryption key between computing devices.

### BACKGROUND

Many vehicles, such as automobiles, drones, and the like, may include computing devices communicating over networking links that allow the vehicle to process data and to communicate with other remote computing devices. In some cases, it may be useful to secure these communications, such as with encryption. Such secure communication may be used for a variety of purposes, such as system updates, traffic information, route guidance, and the like. Many forms of encryption utilize encryption keys (which may be symmetric or asymmetric) to facilitate this encryption. Encryption keys (sometimes referred to as “secrets” or “shared secrets”) enable secure communication with other computing devices that are also privy to the encryption key. For example, in some symmetric encryption scenarios, two computing devices each possess the same encryption key (e.g., a private key), which may allow the devices to encrypt data sent to, and decrypt data received from, the other device. Encryption may be useful in shared networking environments, such as wireless communications, in which the transmissions may be intercepted. Such transmissions, however, may be vulnerable if the encryptions key used to encrypt the communication is compromised.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a schematic block diagram that illustrates an example system, according to some embodiments of the present disclosure.

FIG. 2 is a schematic diagram that illustrates a detection of a traffic state in a proximity of a vehicle, according to some embodiments of the present disclosure.

FIG. 3A is a flow diagram of a method of requesting an update of an encryption key, according to some embodiments of the present disclosure.

FIG. 3B is a flow diagram of a method of requesting an update of an encryption key, according to some embodiments of the present disclosure.

FIG. 4 is a flow diagram of a method for updating an encryption key used by a vehicle, in accordance with some embodiments of the present disclosure

FIG. 5 is a component diagram of an example of a device architecture, in accordance with embodiments of the disclosure.

FIG. 6 is a block diagram that illustrates an example system, according to some embodiments of the present disclosure.

### DETAILED DESCRIPTION

Because access to a shared key may allow for the decryption of otherwise secure communication, the encryption key may be a vector of attack for unauthorized users to attempt to read and/or obtain access to secure communications. For example, an attacker with access to the shared key between two communicating computing devices may decrypt the messages to determine their contents. As another example, if an attacker is able to gain access to a shared key, the attacker may intercept and decrypt messages from each computing device and alter or delete the messages. In some cases, whole new messages may be created by the attacker, which would appear legitimate since they would be encrypted with the shared key. Therefore, the longer a shared key is in use, the more possible it is that the key may be compromised. As a result, shared keys may be rotated periodically, so that potentially compromised keys are no longer used. In addition, periodically rotating the keys may reduce the number of communications that are available for analysis to attempt to identify the shared key, such as through brute force computer cryptanalysis.

To rotate an encryption key (also referred to herein as a “key” or “shared key”) that is used between computing devices, one of the computing devices may request that the key be rotated and/or updated. In response to a request for an updated key, a security computing device (e.g., a key vault service) may generate a new key and store the new key in a key store of the security computing device. The security computing device may mark the prior encryption key as obsolete, but, since the new encryption key has not yet been provided to the computing device requesting the update, the obsolete encryption key may still be used. The security computing device may send the updated encryption key to the requesting computing device. The security computing device may continue to try to transmit the new encryption key until the expiration of a defined time period or the receipt of an acknowledgement message from the requesting computing device (e.g., whichever occurs first). The security computing device may continue to use the obsolete encryption key until the new encryption key is acknowledged by the requesting computing device or until the defined time period expires. Upon receipt of the acknowledgement message from the requesting computing device or the expiration of the time period, the security computing device may delete the obsolete encryption key. At this point, only the new encryption key may be valid for communication with the security computing device. The new encryption key may be valid until the next rotation of the encryption key, at which point the process repeats.

In some cases, the key rotation may be performed on a periodic basis. The key rotation presents a set of conflicting security concerns. On one side, the longer a particular encryption key is used, the more messages may be made with it, which creates more material for the encryption key to be determined. However, during a rotation of the encryption key, the new encryption key is also transmitted over the communication network (albeit encrypted), which may allow the new encryption key to be discovered. It also exposes the possibility that the user of the encryption key (e.g., a computing device of a vehicle) does not receive the new encryption key (e.g., does not receive any of the transmissions of the new encryption key before the time period for the rotation expires). Thus, frequent rotations may also open the communication network to security vulnerabilities.

Computer devices utilized in vehicles may offer additional challenges. Such computing devices typically communicate via wireless technologies, which transmit communications in ways that can be intercepted by others. Such vehicles may also transition between multiple types of networks, which may make securing the network, or only accessing secure networks, more difficult. In addition, vehicles that experience traffic may expose the computing device to additional vulnerabilities. In traffic, or other events that reduce the vehicle speed, the vehicle may be near other vehicles and/or people for an extended length of time. This may allow for the transmissions of the vehicle to be more readily intercepted, and expose the communications to attack. For example, a vehicle traveling at a high rate of speed in relatively light traffic may be exposed to fewer opportunities for attack. In contrast, a vehicle at a standstill in traffic, with numerous adjacent vehicles and/or people, may have an increased number of opportunities for its transmissions to be intercepted by a same attacker, and subject to cryptanalysis.

The present disclosure addresses the above-noted and other deficiencies by providing a technique for rotating a key for a computing device that takes into account traffic in the area of the vehicle and/or computing device in the area of a route of the computing device. For example, in some embodiments, the computing device may be part of a vehicle. As used herein, a “vehicle” may include any apparatus containing a computing device that is capable of movement, either under control of an operator (such as an automobile, train, airplane, bus, boat, truck, motorcycle, for example) or under remote control (such as a drone, for example). A vehicle may include a sensor (such as a global positioning system (GPS) sensor) that is effective to determine the device's location such that a displacement between one location and another location may be determined. The various techniques described herein may be used to trigger a rotation of the encryption key based on the presence of vehicular traffic in the area of the vehicle or along a route of the vehicle that might slow the progress of the vehicle. In some embodiments, the present of presence of traffic in the area of the vehicle or along a route of the vehicle may also be used to trigger an adjustment (e.g., a decrease) of the time period between encryption key rotations.

By reducing a number of messages that are encrypted with a same encryption key, fewer messages may be available to an attacker for brute force cryptanalysis attacks. Linking key rotation with traffic awareness reduces the number of messages encrypted with the same key in situations in which a larger number of attackers may be present. Additionally, many attacks occur from stationary locations (e.g., while a vehicle is within range of an attacker's computing device). Triggering a key rotation more frequently when the vehicle is stopped or moving slowly may reduce a number of messages used with the same encryption key during a time when the vehicle may be in close proximity to such a stationary attacker. In addition, in some embodiments of the present disclosure, even if one encryption key is compromised, it may be rotated more frequently, limiting the usefulness of the compromised encryption key to the attacker. By analyzing the route of the vehicle, some embodiments of the present disclosure may allow for the encryption key to be rotated and/or may increase a frequency at which the encryption key is rotated. This may allow for the encryption key to be rotated proactively prior to entering an environment in which the computing device may be vulnerable to attack.

Embodiments of the present disclosure may provide a technological solution that increases the security of computer technology including networked communications, such as those used in computing devices for vehicles. By adjusting the rotation of an encryption key based on a state of traffic in the area of, or along the route of, a vehicle, attack opportunities against network communications of the computing device may be reduced. In addition, by maintaining a view to the vehicular traffic state on a route of the vehicle, the computing device may proactively adjust its security before an environment for such attack opportunities is present. Embodiments of the present disclosure may improve the operation of a computer in that they more robustly secure the communications of the computer and increase the security of its networked communications.

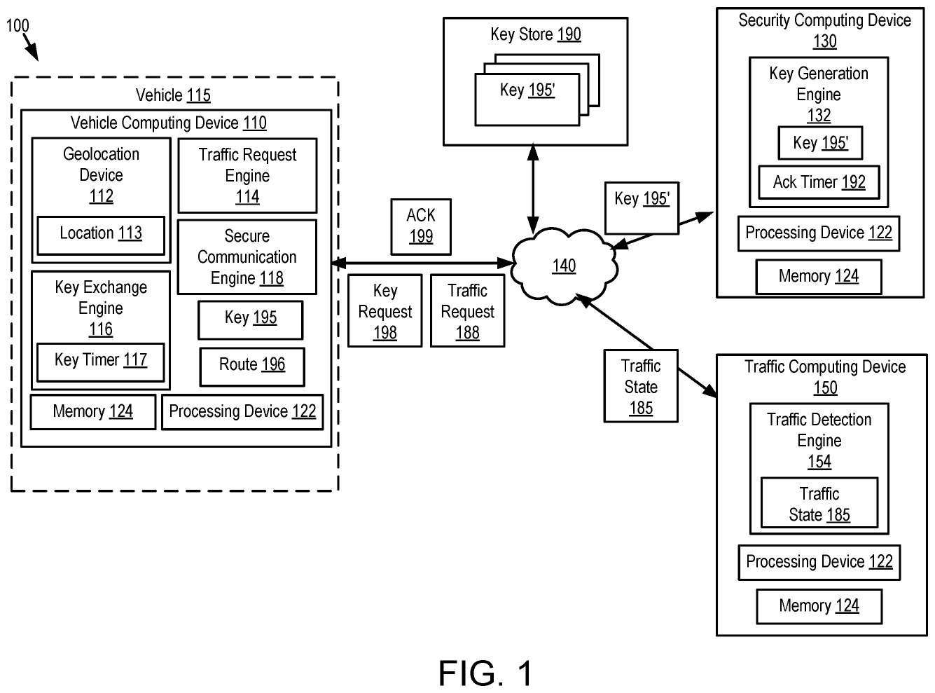

FIG. 1 is a schematic block diagram that illustrates an example system 100, according to some embodiments of the present disclosure. FIG. 1 and the other figures may use like reference numerals to identify like elements. A letter after a reference numeral, such as “220A,” indicates that the text refers specifically to the element having that particular reference numeral. A reference numeral in the text without a following letter, such as “220,” refers to any or all of the elements in the figures bearing that reference numeral.

As illustrated in FIG. 1, the system 100 includes a vehicle computing device 110, a security computing device 130, and a traffic computing device 150. The computing devices 110, 130, and 150 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between the vehicle computing device 110, the security computing device 130, and/or the traffic computing device 150.

Each computing device 110, 130, and 150 may include hardware such as processing device 122 (e.g., processors, central processing units (CPUs), memory 124 (e.g., random access memory (e.g., RAM), storage devices (e.g., hard-disk drive (HDD), solid-state drive (SSD), etc.), and other hardware devices (e.g., sound card, video card, etc.).

Processing device 122 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 122 may also include one or more special-purpose processing devices such as an application specific integrated circuit (ASIC), a field programmable gate array (FPGA), a digital signal processor (DSP), network processor, or the like.

Memory 124 may include volatile memory devices (e.g., random access memory (RAM)), non-volatile memory devices (e.g., flash memory) and/or other types of memory devices. In certain implementations, memory 124 may be non-uniform access (NUMA), such that memory access time depends on the memory location relative to processing device 122. In some embodiments, memory 124 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 124 may be configured for long-term storage of data and may retain data between power on/off cycles of the computing devices 110, 130, and 150.

Each computing device 110, 130, and 150 may comprise any suitable type of computing device or machine that has a programmable processor including, for example, server computers, desktop computers, laptop computers, tablet computers, smartphones, set-top boxes, systems on a chip (SOC), embedded computing devices, etc. In some examples, each of the computing devices 110, 130, and 150 may comprise a single machine or may include multiple interconnected machines (e.g., multiple servers configured in a cluster). The computing devices 110, 130, and 150 may be implemented by a common entity/organization or may be implemented by different entities/organizations. For example, vehicle computing device 110 may be operated by a first company/corporation, the security computing device 130 may be operated by a second company/corporation, and/or the traffic computing device 150 may be operated by a third company/corporation.

The vehicle computing device 110 may be a computing device installed and/or present in a vehicle 115. In some embodiments, the vehicle 115 computing device 110 may be a part of an automobile, though the embodiments of the present disclosure are not limited to such a configuration. The vehicle computing device 110 may include a geolocation device 112, a traffic request engine 114, a key exchange engine 116, and a secure communication engine 118.

The secure communication engine 118 may be configured to generate secure communications for interactions with the network 140. For example, the secure communication engine 118 may be configured to encrypt/decrypt communications on the network 140 using an encryption key 195 (e.g., a private encryption key used in symmetric encryption). For example, the secure communication engine 118 may be configured to encrypt communications on the network 140 in order to receive software updates and/or communicate various data (e.g., traffic information, local shopping options, entertainment options, weather information, service alerts, etc.) to/from the vehicle 115.

The key exchange engine 116 may be configured to rotate the encryption key 195 used by the secure communication engine 118 to encrypt the communications on the network 140. In some embodiments, the encryption key 195 may be rotated according to the various techniques described herein so that the encryption key 195 is changed over time to mitigate the risk of a successful man-in-the-middle attack.

The key exchange engine 116 may be configured to communicate with the security computing device 130 to update/rotate the encryption key 195. For example, the vehicle computing device 110 may be configured to request a rotation of the encryption key 195 by sending a key request 198 to the security computing device 130 over network 140.

Upon receipt of the key request 198, a key generation engine 132 of the security computing device 130 may generate a new encryption key 195′ and may send the new encryption key 195′ to the vehicle computing device 110 via network 140. In some embodiments, the security computing device 130 may store the new encryption key 195′ in key store 190 for future use.

In some embodiments, the key generation engine 132 of the security computing device 130 may initiate an acknowledgement (ack) timer 192 upon transmitting the new encryption key 195′ to the vehicle computing device 110. Until expiration of the acknowledgement timer 192, both the new encryption key 195′ and the old encryption key 195 may remain valid (e.g., for encrypting communications on the network 140). If the security computing device 130 receives an acknowledgement message “ACK” 199 from the vehicle computing device 110 indicating that the new encryption key 195′ has been received by the vehicle computing device 110, the old encryption key 195 may be deleted. Thereafter, only the new encryption key 195′ may be valid. Until expiration of the acknowledgement timer 192, the security computing device 130 may repeat a transmission of the new encryption key 195′ to the vehicle computing device 110 until either the acknowledgement message 199 is received or until expiration of the acknowledgement timer 192. Upon expiration of the acknowledgement timer 192, the old encryption key 195 may be deleted and the new encryption key 195′ may be used for further transmission on the network 140. In some embodiments, for example, a first encryption key 195 may be used to generate first encrypted data to be transmitted over the network 140 (e.g., to a remote computing device). After rotating the encryption key 195, a new encryption key 195′ may be used to generate second encrypted data to be transmitted over the network 140.

In some embodiments, the vehicle computing device 110 may be configured to send a key request 198 to exchange the encryption key 195 after a preset duration passes, which may be maintained by the key exchange engine 116 as a key timer 117. Thus, whenever the key timer 117 expires, a new key request 198 may be transmitted to the security computing device 130 to request a new encryption key 195′.

The key exchange engine 116 is not limited to requesting an exchange of the encryption key 195 upon expiration of the key timer 117. In some embodiments, the key request 198 may also be transmitted in response to other events and/or situations. For example, in some embodiments, the exchange of the key 195 may be based on other factors, such as a distance traveled or a state of a battery of the vehicle 115. A description of other scenarios that might be utilized for the exchange of the key 195 are discussed, for example, in U.S. patent application Ser. No. 17/376,851, filed on Jul. 15, 2021.

In some embodiments, the key request 198 may also be transmitted in response to a state of vehicular traffic in proximity to the vehicle 115, or in proximity to a route of the vehicle 115. For example, in some embodiments, the key request 198 to request the rotation of the key 195 may be transmitted to the security computing device 130 in response to detecting that a level of traffic in the proximity of the vehicle 115 and/or vehicle computing device 110 exceeds a defined level.

To detect a state of the traffic in the proximity of the vehicle 115, the vehicle computing device 110 may communicate (e.g., over network 140) with traffic computing device 150. For example, the traffic request engine 114 may send a traffic request 188 to the traffic computing device 150. In some embodiments, the traffic request 188 may include a current location 113 of the vehicle computing device 110 and/or the vehicle 115.

The vehicle computing device 110 may include a geolocation device 112 to determine the current location 113 of the vehicle computing device 110 and/or the vehicle 115. In some embodiments, the geolocation device 112 may be a global positioning system (GPS) device. Embodiments of the present disclosure are not limited to a GPS system. In some embodiments, the geolocation device 112 may be configured to detect a location 113 of the vehicle computing device 110 and/or the vehicle 115 based on radio signal triangulation, such as with cell towers, WiFi transmissions, or other transmitting devices.

In some embodiments, the traffic request 188 may include a route 196 of the vehicle 115. The route 196 may indicate a planned path of the vehicle 115. In some embodiments, the route 196 may be a path along roadways, but the embodiments of the present disclosure are not limited thereto. In some embodiments, the vehicle 115 may be airborne (e.g., may be a drone) and the route 196 may be a path through the air, such as a flight path. In some embodiments, the route 196 may be entered by a user of the vehicle 115 into the vehicle computing device 110 (e.g., into a navigation system of the vehicle 115), but embodiments of the present disclosure are not limited to such a configuration. In some embodiments, the vehicle computing device 110 may automatically detect the route 196 based on a history of travel, or by accessing a current navigation system of the vehicle 115, such as an autonomous driving circuit of the vehicle 115, or other route planning circuit.

In response to the traffic request 188, a traffic detection engine 154 of the traffic computing device 150 may generate a traffic state 185 of the vehicle computing device 110 and/or the vehicle 115. In some embodiments, the traffic detection engine 154 may base the traffic state 185 on the location 113 and/or the route 196 of the vehicle. In some embodiments, the traffic state 185 may be provided to the vehicle computing device 110 the by traffic detection engine 154 of the traffic computing device 150 as a transmission on network 140. In some embodiments, the traffic state 185 transmitted on the network 140 may be the traffic state 185 itself, though the embodiments of the present disclosure are not limited to such a configuration. In some embodiments, the traffic state 185 transmitted on the network 140 may include sufficient data such that the vehicle computing device 110 (e.g., the traffic request engine 114) may be able to calculate the traffic state 185.

As used herein, the traffic state 185 may be a state of vehicular traffic. The traffic state 185 may refer to a number of other vehicles in the vicinity of the vehicle 115. For example, if the vehicle 115 is an automobile, the traffic state 185 may refer to a number of other automobiles in the vicinity of the vehicle 115, but may also include other types of vehicles, such as bicycles and/or motorcycles. In some embodiments, the other vehicles may be of a same type as the vehicle 115, but the embodiments of the present disclosure are not limited to such a configuration. For example, if the vehicle 115 is a drone, the traffic state 185 may refer to a number of other drones in the vicinity of the vehicle 115. In some embodiments, a level of the traffic state 185 may exceed a defined level if the number of vehicles in proximity to (e.g., within a particular distance of) vehicle 115 exceed a defined number.

In some embodiments, the traffic state 185 may be based on a speed of the vehicle 115. For example, a current speed of the vehicle 115 may be detected and compared to a posted speed on the route 196 upon which the vehicle 115 is traveling. In some embodiments, a level of the traffic state 185 may exceed a defined level if the speed of the vehicle 115 deviates from (e.g., is less than) the posted speed (e.g., a speed limit) on the route 196 more than a defined percentage (e.g., 10%, 20%, 30%) and/or by a set amount (e.g., 10 mph, 20 mph). In some embodiments, the traffic computing device 150 may maintain a database of posted speeds to compare to the route 196. In some embodiments, the traffic detection engine 154 may be configured to receive the speed of the vehicle 115 from the vehicle computing device 110, or to determine the speed of the vehicle 115 in response to receiving a plurality of locations 113 from the vehicle computing device 110.

Though illustrated as a separate computing device, in some embodiments, the traffic computing device 150 may be a same computing device as the security computing device 130. For example, the traffic detection functions of the traffic computing device 150 (e.g., the traffic detection engine 154) and the key generation functions of the security computing device 130 (e.g., the key generation engine 132) may both be performed by a single computing device, though the embodiments of the present disclosure are not limited to such a configuration.

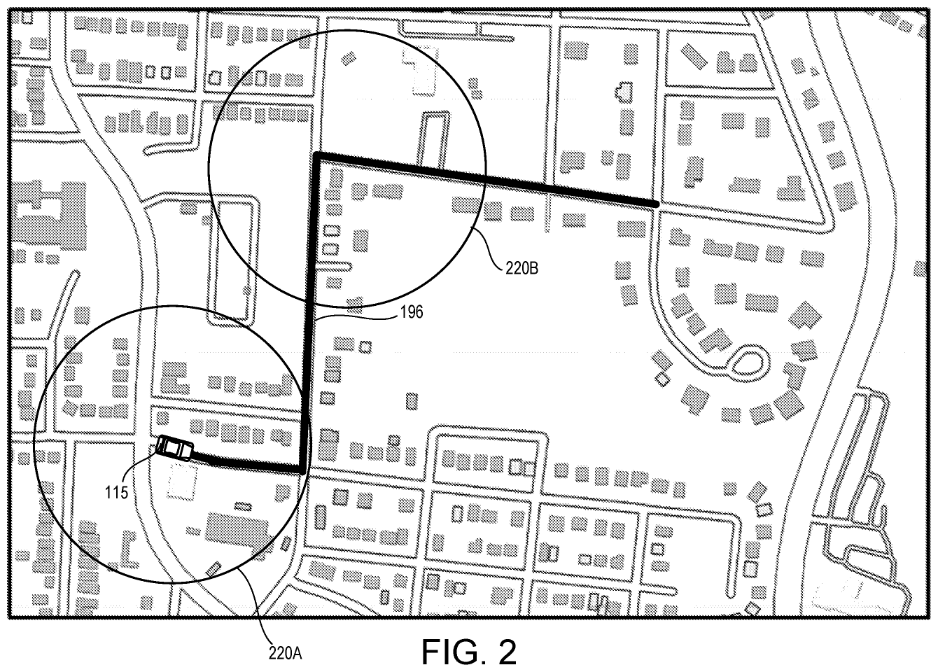

FIG. 2 is a schematic diagram that illustrates a detection of a traffic state 185 in a proximity of a vehicle 115, according to some embodiments of the present disclosure. A description of elements of FIG. 2 that have been previously described will be omitted for brevity.

Referring to FIGS. 1 and 2, a vehicle 115 may be traveling on a route 196. In FIG. 2, the vehicle 115 is illustrated as an automobile and the route 196 is illustrated as a path along roadways, but the embodiments of the present disclosure are not limited thereto. In some embodiments, the vehicle 115 may be airborne (e.g., may be a drone) and the route 196 may be a path through the air, such as a flight path. Other types of vehicles 115 and routes 196 are contemplated within the embodiments of the present disclosure.

The vehicle 115 may be configured to detect a traffic state 185 (see FIG. 1) in its proximity. For example, the vehicle 115 may be configured to detect the traffic state 185 within a first area 220A of the vehicle 115. In some embodiments, the first area 220A may be an area that surrounds the vehicle 115. For example, the first area 220A may be calculated as a circle, with the vehicle 115 at the center. However, the embodiments of the present disclosure are not limited to such a configuration. In some embodiments the first area 220A may be configured to enclose an area in front of the vehicle 115. For example, the vehicle 115 may not necessarily consider traffic that is behind the vehicle 115 in some embodiments.

In some embodiments, a size of the first area 220A may include a circle having a radius of 1 mile, 2 miles, 5 miles, or larger. In some embodiments, the size of the first area 220A may be based on a speed of the vehicle 115. For example, the size of the first area 220A may be dynamically increased as a speed of the vehicle 115 is increased.

In some embodiments, the traffic state 185 may be detected by transmitting a current location 113, speed of the vehicle, and/or route 196 of the vehicle 115 to a traffic detection engine 154 of the traffic computing device 150, as described herein with respect to FIG. 1. The traffic computing device 150 may be configured to calculate the traffic state 185 within the first area 220A and/or may be able to transmit sufficient data to the vehicle computing device 110 such that the vehicle computing device 110 may calculate the traffic state 185.

In some embodiments, the vehicle 115 may be further configured to detect the traffic state 185 within a second area 220B of the route 196 of the vehicle 115. In some embodiments, the second area 220B may be an area that includes a portion of the route 196 that the vehicle 115 is to be traveling upon within a determined period of time. For example, the second area 220B may be calculated as a circle, with the portion of the route 196 at the center. However, the embodiments of the present disclosure are not limited to such a configuration. In some embodiments the second area 220B may be configured to enclose a portion of the route 196 for a particular distance (e.g., 1 miles, 5 miles, etc.). In some embodiments, the second area 220B may include the entire route 196 of the vehicle to its final destination.

In some embodiments, the traffic state 185 of the second area 220B may be based on a number of other vehicles within the second area 220B of the route 196. For example, the traffic detection engine 154 of the traffic computing device 150 may be in communication with other vehicles in addition to vehicle 115. Based on communications with the other vehicles, the traffic detection engine 154 may be configured to detect a number of vehicles along the route 196 of the vehicle 115, as well as current speeds of those other vehicles. In some embodiments, the traffic detection engine 154 may be configured to detect the traffic state 185 of a future portion of the route 196 of the vehicle 115 by detecting that a current speed of other vehicles currently on that future portion of the route 196 are driving below a posted speed limit.

Referring back to FIG. 1, embodiments of the present disclosure may allow for the rotations of the encryption key 195 in response to determining that the traffic state 185 exceeds a particular level. For example, upon receipt of the traffic state 185 from the traffic detection engine 154 (or upon calculation of the traffic state 185 from the data returned by the traffic detection engine 154), the traffic state 185 may be examined. For example, if the traffic state 185 exceeds a define level, the key request 198 may be transmitted to the security computing device 130 to generate a new encryption key 195′.

In some embodiments, the key request 198 may be transmitted to the security computing device 130 in response to determining that a traffic state 185 of a first area 220A (see FIG. 2) that encompasses the vehicle 115 exceeds a defined level. For example, the traffic request engine 114 may determine that a number of other vehicles in proximity to vehicle 115 (e.g., within the first area 220A) exceeds a defined amount. In some embodiments, the traffic request engine 114 may determine that the vehicle 115 is driving more than a defined amount below a posted speed of the route 196. Upon determining that the traffic state 185 of the first area 220A exceeds the defined level, the traffic request engine 114 may communicate with the key exchange engine 116 to request the generation of a new encryption key 195′.

In some embodiments, the key request 198 may be transmitted to the security computing device 130 in response to determining that a traffic state 185 of a second area 220B (see FIG. 2) that encompasses the route 196 of the vehicle 115 exceeds a defined level. For example, the traffic request engine 114 may determine that a number of other vehicles along the route 196 exceeds a defined amount. In some embodiments, the traffic request engine 114 may determine that vehicles along the route 196 are driving more than a defined amount below a posted speed of that portion of the route 196. Upon determining that the traffic state 185 of the second area 220B exceeds the defined level, the traffic request engine 114 may communicate with the key exchange engine 116 to request the generation of a new encryption key 195′.

In some embodiments, in addition to requesting an exchange of the encryption key 195, the key exchange engine 116 may also be configured to adjust the key timer 117 in response to determining that the traffic state 185 of the first area 220A exceeds the defined level and/or the traffic state 185 of the second area 220B exceeds the defined level. For example, a duration of the key timer 117 may be reduced so that a key request 198 is sent more frequently to exchange the encryption key 195.

As described herein, embodiments of the present disclosure may allow for an encryption key 195 to be rotated and/or rotated more frequently, in response to determining that a traffic state 185 indicates that a traffic level in proximity to the vehicle 115 is increasing and/or that a traffic level along the route 196 of the vehicle 115 is increasing. Replacing the encryption key 195 may allow for a possibly compromised key 195 to be renewed. Rotating the encryption key 195 more frequently (e.g., by adjusting the key timer 117) may allow for a particular encryption key 195 to be utilized for a shorter duration, reducing a number of messages using the encryption key 195 as well as reducing a duration during which a compromised encryption key 195 would be useful. By replacing the encryption key 195 and/or rotating the encryption key more frequently in response to increased vehicular traffic, the encryption key 195 may be used for fewer message in situations in which the vehicle 115 may be likely to be in proximity to an attacker for a longer period of time. In this way, the communications of the vehicle computing device 110 may improved to be more secure and/or less vulnerable to compromise/attack.

Though the embodiments described herein describe a vehicle computing device 110 as part of a vehicle 115, embodiments of the present disclosure are not limited to such a configuration. In some embodiments, the vehicle computing device 110 may be a mobile computing device 110, such as a smart phone. For example, in some embodiments, a key 195 of a mobile computing device 110 may be rotated based on traffic in proximity to the mobile computing device 110. For example, a mobile computing device 110 carried by a pedestrian may include an encryption key 195 for communication with a network 140. In some embodiments, the encryption key 195 of the mobile computing device 110 may be rotated and/or rotated more frequently in response to determining that the mobile computing device 110 is in a crowd (e.g., a traffic state 185 indicates a large number of other people and/or mobile devices in the vicinity of the mobile computing device 110). In this way, benefits described herein with respect to vehicle computing devices 110 may be applied to other types of mobile computing device 110, such as smart phones.

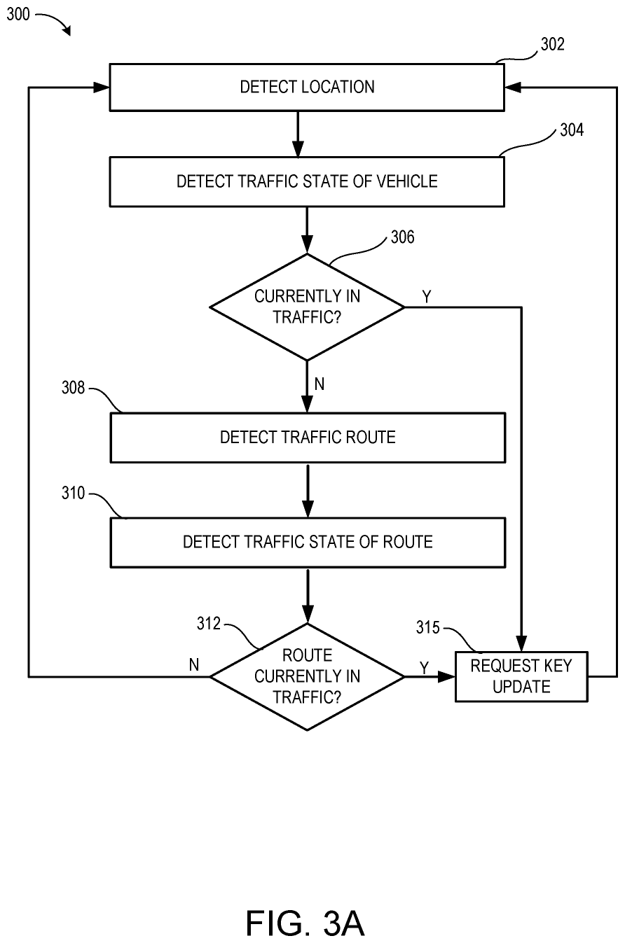

FIG. 3A is a flow diagram of a method 300 of requesting an update of an encryption key 195, according to some embodiments of the present disclosure. A description of elements of FIG. 3A that have been previously described will be omitted for brevity. Method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 300 may be performed by a computing device (e.g., vehicle computing device 110).

With reference to FIG. 3A, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

Referring simultaneously to FIGS. 1 and 3A as well, the method 300 begins at block 302, in which a location 113 of a vehicle 115 is detected. In some embodiments, the location 113 of the vehicle 115 may be detected by a geolocation device 112, such as the geolocation device 112 described herein with respect to FIG. 1. In some embodiments, the location 113 of the vehicle 115 may be detected by a GPS device.

At block 304, a traffic state 185 of the vehicle 115 may be detected. In some embodiments, the traffic state 185 of the vehicle 115 may be detected by a traffic detection engine 154 of a traffic computing device 150, and may be detected based on a transmitted traffic request 188 from the vehicle 115. In some embodiments, the traffic state 185 may be indicative of a number of other vehicles that are in a first area 220A that encompasses the vehicle 115. In some embodiments, the traffic state 185 may be indicative that the vehicle 115 is traveling at a speed that is below a posted speed limit of the route 196 of the vehicle 115. The traffic state 185 may indicate whether the vehicle 115 is currently in traffic (e.g., a state of vehicular traffic).

At block 306, it may be determined if the vehicle 115 is currently in traffic. Determining whether the vehicle 115 is currently in traffic may include comparing the traffic state 185 of the vehicle 115 to a defined level. For example, the vehicle 115 may be determined to be in traffic if a number of other vehicles in proximity to the vehicle 115 is larger than a defined number. In some embodiments, the vehicle 115 may be determined to be in traffic if the vehicle 115 is traveling at a speed that is below a posted speed limit of the route 196 of the vehicle 115.

If the vehicle 115 is determined to be currently in traffic (block 306: Y), operations may continue to block 315 in which an update of the encryption key 195 is requested. Requesting an update of the encryption key 195 may include transmitting a key request 198 to a key generation engine 132 of a security computing device 130. As described herein with respect to FIG. 1, in response to the key request 198, the security computing device 130 may generate a new encryption key 195′, and transmit the new encryption key 195′ to the vehicle computing device 110 of the vehicle 115. Operations may return to block 302 to continue to monitor traffic in proximity to the vehicle 115 and to a route 196 of the vehicle 115.

If the vehicle 115 is determined to not be currently in traffic (block 306: N), operations may continue to block 308 in which a route 196 of the vehicle 115 may be detected. In some embodiments, the route 196 of the vehicle 115 may be a path upon which the vehicle 115 is traveling. In some embodiments, the route 196 may be entered by a user of the vehicle 115, but embodiments of the present disclosure are not limited to such a configuration. In some embodiments, the vehicle computing device 110 may automatically detect the route 196 based on a history of travel, or by accessing a current navigation system of the vehicle 115, such as an autonomous driving circuit of the vehicle 115.

At block 310, a traffic state 185 of the route 196 of the vehicle 115 may be detected. In some embodiments, the traffic state 185 of the route 196 of the vehicle 115 may be detected by the traffic detection engine 154 of the traffic computing device 150, and may be detected based on a transmitted traffic request 188 and/or knowledge of the route 196 of the vehicle 115. In some embodiments, the traffic state 185 of the route 196 may be indicative of a number of other vehicles that are in a second area 220B that encompasses a portion of the route 196 upon which the vehicle 115 will travel in the future. In some embodiments, the traffic state 185 of the route 196 may be indicative that the other vehicles currently within the second area 220B are traveling at a speed that is below a posted speed limit of that portion of the route 196.

At block 312, it may be determined if the route 196 of the vehicle 115 is currently in traffic. Determining whether the route 196 of the vehicle 115 is currently in traffic may include comparing the traffic state 185 of other vehicles along that portion of the route 196 to a defined level. For example, the route 196 of the vehicle 115 may be determined to be in traffic if a number of other vehicles along that portion of the route 196 is larger than a defined number. In some embodiments, the route 196 of the vehicle 115 may be determined to be in traffic if the other vehicles along that portion of the route 196 are traveling at a speed (e.g., an average speed of the other vehicles) that is below a posted speed limit of that portion of the route 196 of the vehicle 115.

If the route 196 of the vehicle 115 is determined to be currently in traffic (block 312: Y), operations may continue to block 315 in which an update of the encryption key 195 is requested, as previously described. If the route 196 of the vehicle 115 is determined to not be currently in traffic (block 312: N), operations may return to block 302 to continue to monitor traffic in proximity to the vehicle 115 and to the route 196 of the vehicle 115.

The method 300 illustrated in FIG. 3A may allow for an algorithm to adjust an update of an encryption key 195 responsive to a detected traffic state 185 of a vehicle 115 and/or a route 196 of the vehicle 115. The method 300 may allow for the encryption key 195 to be replaced prior to environments and/or states when the encryption key 195 may be vulnerable to attack. This additional information may enhance the computer technology of encrypted network communication by allowing for network communications that are less vulnerable to attack.

As described herein, in some embodiments, a key timer 117 may be adjusted in response to the traffic state 185 so as to begin rotating the encryption key 195 more frequently prior to a traffic event. FIG. 3B is a flow diagram of a method 350 of requesting an update of an encryption key 195, according to some embodiments of the present disclosure. A description of elements of FIG. 3B that have been previously described will be omitted for brevity. Method 350 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 350 may be performed by a computing device (e.g., vehicle computing device 110).

With reference to FIG. 3B, method 350 illustrates example functions used by various embodiments. Although specific function blocks (“blocks”) are disclosed in method 350, such blocks are examples. That is, embodiments are well suited to performing various other blocks or variations of the blocks recited in method 350. It is appreciated that the blocks in method 350 may be performed in an order different than presented, and that not all of the blocks in method 350 may be performed.

Referring simultaneously to FIGS. 1, 3A, and 3B as well, the method 350 begins at block 352, in which a key timer 117 is set. The key timer 117 may indicate a duration after which a key request 198 will be made to rotate the encryption key 195. In some embodiments, the key timer 117 may be initially set to a default value.

At block 302, a location 113 of a vehicle 115 is detected. The operations of block 302, as well as those of blocks 304, 306, 308, 310, 312, and 315 may be substantially similar to those of FIG. 3A, and a repeated description thereof will be omitted and/or reduced.

At block 304, a traffic state 185 of the vehicle 115 may be detected and, at block 306, it may be determined if the vehicle 115 is currently in traffic. If the vehicle 115 is determined to be currently in traffic (block 306: Y), operations may continue to block 354 in which the key timer 117 is adjusted. In some embodiments, the key timer 117 may be adjusted to reduce a duration that is to elapse before a key request 198 is sent to the security computing device 130 to update the encryption key 195. Stated another way, adjusting the key timer 117 may result in the encryption key 195 being replaced more frequently. After updating the key timer 117, operations may continue to block 315, where an update of the encryption key 195 is requested, as described herein with respect to FIG. 3A.

At block 308, the traffic route 196 of the vehicle may be detected and, at block 310, a traffic state 185 of the route 196 of the vehicle 115 may be detected. At block 312, it may be determined if the route 196 of the vehicle 115 is currently in traffic. If the route 196 of the vehicle 115 is determined to be currently in traffic (block 312: Y), operations may continue to block 354 in which the key timer 117 is updated and block 315 in which an update of the encryption key 195 is requested, as previously described. After requesting the key update, operations may return to block 302 to continue to monitor traffic in proximity to the vehicle 115 and to a route 196 of the vehicle 115.

If the route 196 of the vehicle 115 is determined to not be currently in traffic (block 312: N), operations may continue to block 356 in which it is determined whether the key timer 117 has expired (e.g., whether a duration of time associated with the key timer 117 has passed). If the key timer 117 has expired (block 356:Y), operations may continue to block 315 in which an update of the encryption key 195 is requested, as previously described. After requesting the key update, operations may return to block 302 to continue to monitor traffic in proximity to the vehicle 115 and to a route 196 of the vehicle 115.

In FIG. 3B, if the key timer 117 has not expired (block 356:N), the method 350 may include block 358, in which the key timer 117 is reset (e.g., to a default value). At block 358, the method 350 has determined that the vehicle 115 is not in traffic, the route 196 of the vehicle 115 is not in traffic, and the key timer 117 has not expired. Therefore, at block 358, the key timer 117 may be reset to the default value. As illustrated by method 350, the key timer 117 may be updated to a smaller value again if traffic is detected again in proximity to the vehicle 115 and/or the route 196 of the vehicle 115.

Method 350 may provide that a frequency at which an encryption key 195 is updated may be increased in response to detecting traffic in proximity to the vehicle 115 and/or the route 196 of the vehicle 115. Increasing the frequency of the rotation of the encryption key 195 during traffic may serve to replace the encryption key 195 more frequently in environments and/or situations in which the encryption key 195 is more vulnerable to attack (e.g., when prolonged use of the encryption key 195 might otherwise be performed in proximity to a same location).

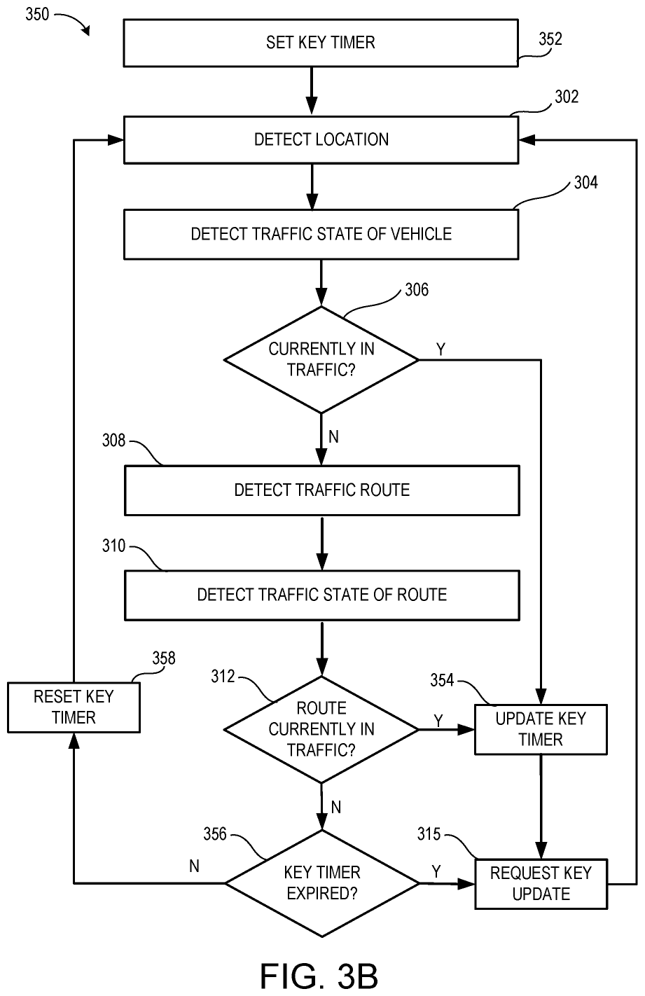

FIG. 4 is a flow diagram of a method 400 for updating an encryption key 195 used by a vehicle 115, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., vehicle computing device 110 illustrated in FIGS. 1 to 3B).

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring simultaneously to FIGS. 1 to 3B as well, the method 400 begins at block 410, in which a first location of a vehicle is detected. In some embodiments, the location and the vehicle may correspond to the location 113 and the vehicle 115, respectively, as described herein with respect to FIGS. 1 to 3B.

At block 420, a state of vehicular traffic is detected in a first area encompassing the first location of the vehicle. In some embodiments, the state of vehicular traffic may correspond to the traffic state 185 described herein with respect to FIGS. 1 to 3B. In some embodiments, the first area may correspond to the first area 220A described herein with respect to FIGS. 1 to 3B. In some embodiments, detecting the state of the vehicular traffic in the first area encompassing the first location of the vehicle includes at least one of determining a number of other vehicles within the first area or comparing a current speed of the vehicle to a posted speed of a route upon which the vehicle is traveling. In some embodiments, detecting the state of the vehicular traffic in the first area encompassing the first location of the vehicle includes transmitting a second request comprising the first location of the vehicle to the remote computing device to retrieve the vehicular traffic in the first area. In some embodiments, the remote computing device may include functions corresponding to the traffic detection engine 154 described herein with respect to FIGS. 1 to 3B.

At block 430, a first request is sent to a remote computing device to update the encryption key. In some embodiments, the encryption key may correspond to the encryption key 195 described herein with respect to FIGS. 1 to 3B. The first request is sent based at least in part on the state of the vehicular traffic in the first area. In some embodiments, the first request may correspond to the key request 198 described herein with respect to FIGS. 1 to 3B.

In some embodiments, the method 400 may further include sending a second request to update the encryption key responsive to an expiration of a time period. In some embodiments, the time period may correspond to the key timer 117 described herein with respect to FIGS. 1 to 3B. In some embodiments, the method 400 may further include updating the time period based at least in part on the state of the vehicular traffic in the first area.

In some embodiments, the method 400 may further include detecting a route along which the vehicle is traveling, detecting a state of vehicular traffic in a second area encompassing the route along which the vehicle is traveling, and sending a second request to the remote computing device to update the encryption key. The second request is sent based at least in part on the state of the vehicular traffic in the second area. In some embodiments, the route along which the vehicle is traveling may correspond to the route 196 described herein with respect to FIGS. 1 to 3B. In some embodiments, the second area may correspond to the second area 220B described herein with respect to FIGS. 1 to 3B.

In some embodiments, the method 400 may further include encrypting first data using a first encryption key to generate first encrypted data, sending the first encrypted data to at least one other computing device over a network, receiving a second encryption key in response to the first request, and encrypting second data using the second encryption key to generate second encrypted data.

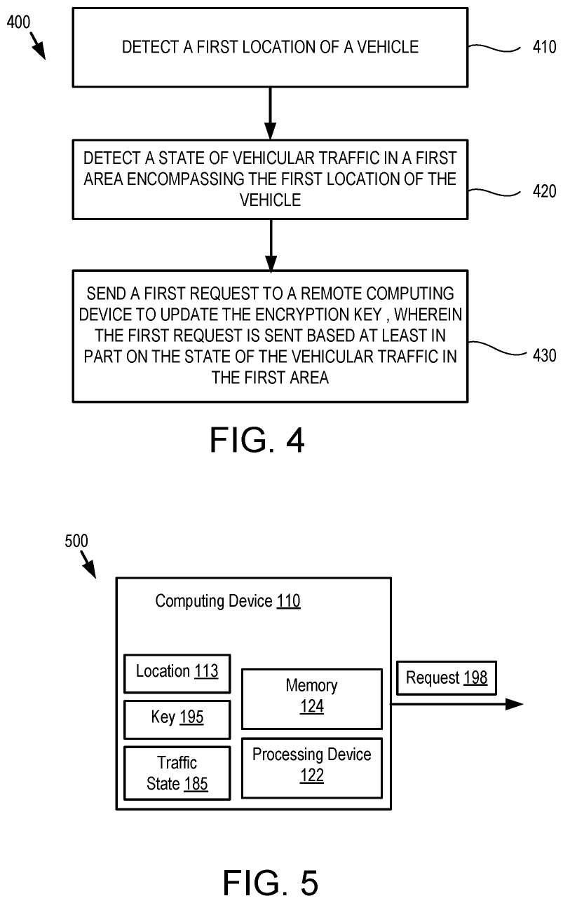

FIG. 5 is a component diagram of an example of a device architecture 500, in accordance with embodiments of the disclosure. The device architecture 500 includes computing device 110 having processing device 122 and memory 124, as described herein with respect to FIGS. 1 to 4.

The computing device 110 may detect a first location 113 of a vehicle 115. The first location 113 may be detected from a geolocation device 112, such as a GPS device, as described herein with respect to FIGS. 1 to 4.

The computing device 110 may detect a state of vehicular traffic 185 in a first area 220A (see FIG. 2) encompassing the first location of the vehicle 115. In some embodiments, the state of vehicular traffic 185 may be detected from a traffic computing device, such as traffic computing device 150 described herein with respect to FIGS. 1 to 4. In some embodiments, detecting the state of the vehicular traffic in the first area encompassing the first location of the vehicle may include determining a number of other vehicles within the first area and/or comparing a current speed of the vehicle to a posted speed of a route upon which the vehicle is traveling.

In some embodiments, the vehicle 115 may include an encryption key 195 that may be used to encrypt data transmitted by the computing device 110. The computing device 110 may send a first request 198 to a remote computing device to update the encryption key 195. In some embodiments, the remote computing device may be a security computing device configured to generate a new encryption key 195′, such as security computing device 130 described herein with respect to FIGS. 1 to 4. The first request 198 may be sent based at least in part on the state of the vehicular traffic 185 in the first area 220A.

The device architecture 500 of FIG. 5 provides a technological capability to dynamically adjust the rotation of an encryption key used by a vehicle in encryption of secure communications based on a state of vehicular traffic in an area encompassing the vehicle as well as a state of vehicular traffic along a route of the vehicle. Embodiments of the present disclosure may improve the technology associated with network encryption by reducing an amount of time that an encryption key is used responsive to detecting that an environment exists, or may soon exist, in which the vehicle may be in a same or similar area for an extended period of time.

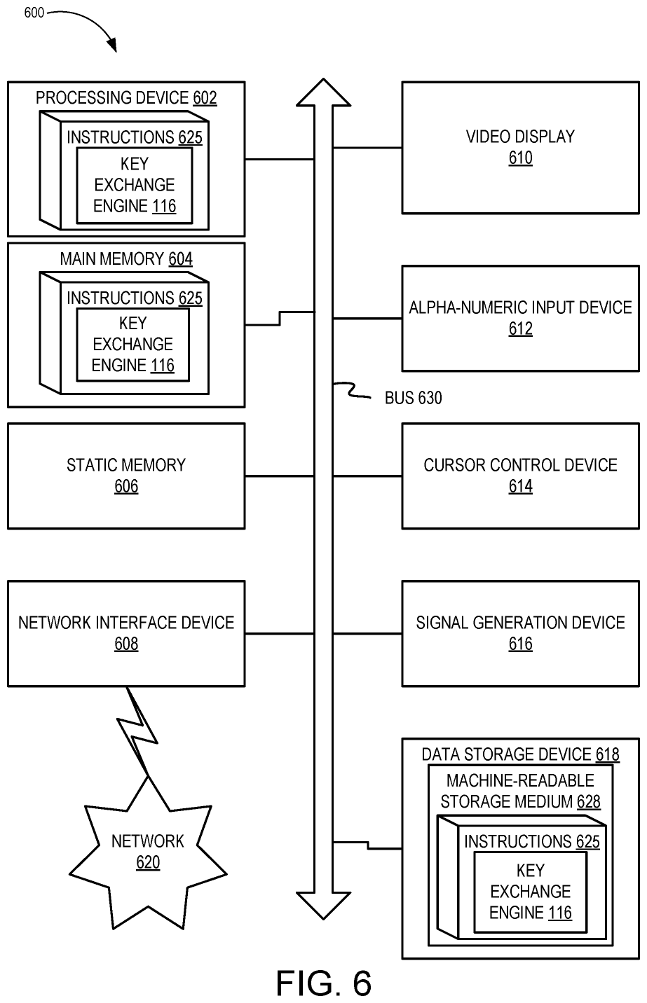

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a component (e.g., key exchange engine 116 discussed herein) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “detecting,” “sending,” “updating,” “determining,” “comparing,” “encrypting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the term “engine” is not intended to be limiting of any particular implementation for accomplishing and/or performing the actions, operations, processes, etc., attributable to and/or performed by the engine. An engine may be, but is not limited to, software, hardware and/or firmware or any combination thereof that performs the specified functions including, but not limited to, any use of a general and/or specialized processing device in combination with appropriate software loaded or stored in a machine readable memory and executed by the processing device. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of updating an encryption key used by a vehicle to encrypt data, the method comprising:
detecting a first location of the vehicle;
detecting a state of vehicular traffic in a first area encompassing the first location of the vehicle; and
sending, by a processing device, a first request to a remote computing device to update the encryption key, wherein the first request is sent based at least in part on the state of the vehicular traffic in the first area.

2. The method of claim 1, further comprising:
sending a second request to update the encryption key responsive to an expiration of a time period.

3. The method of claim 2, further comprising:
updating the time period based at least in part on the state of the vehicular traffic in the first area.

4. The method of claim 1, wherein detecting the state of the vehicular traffic in the first area encompassing the first location of the vehicle comprises at least one of determining a number of other vehicles within the first area or comparing a current speed of the vehicle to a posted speed of a route upon which the vehicle is traveling.

5. The method of claim 1, further comprising:
detecting a route along which the vehicle is traveling;
detecting a state of vehicular traffic in a second area encompassing the route along which the vehicle is traveling; and
sending a second request to the remote computing device to update the encryption key, wherein the second request is sent based at least in part on the state of the vehicular traffic in the second area.

6. The method of claim 1, further comprising:
encrypting first data using a first encryption key to generate first encrypted data;
sending the first encrypted data to at least one other computing device over a network;
receiving a second encryption key in response to the first request; and
encrypting second data using the second encryption key to generate second encrypted data.

7. The method of claim 1, wherein detecting the state of the vehicular traffic in the first area encompassing the first location of the vehicle comprises sending a second request comprising the first location of the vehicle to the remote computing device to retrieve the vehicular traffic in the first area.

8. A system comprising:
a memory; and
a processing device, operatively coupled to the memory, to:
detect a first location of a vehicle, the vehicle comprising an encryption key used by a vehicle to encrypt data;
detect a state of vehicular traffic in a first area encompassing the first location of the vehicle; and
send a first request to a remote computing device to update the encryption key, wherein the first request is sent based at least in part on the state of the vehicular traffic in the first area.

9. The system of claim 8, wherein the processing device is further to send a second request to update the encryption key responsive to an expiration of a time period.

10. The system of claim 9, wherein the processing device is further to update the time period based at least in part on the state of the vehicular traffic in the first area.

11. The system of claim 8, wherein, to detect the state of the vehicular traffic in the first area encompassing the first location of the vehicle, the processing device is to perform at least one of determining a number of other vehicles within the first area or comparing a current speed of the vehicle to a posted speed of a route upon which the vehicle is traveling.

12. The system of claim 8, wherein the processing device is further to:
detect a route along which the vehicle is traveling;
detect a state of vehicular traffic in a second area encompassing the route along which the vehicle is traveling; and
send a second request to the remote computing device to update the encryption key, wherein the second request is sent based at least in part on the state of the vehicular traffic in the second area.

13. The system of claim 8, wherein the processing device is further to:
encrypt first data using a first encryption key to generate first encrypted data;
send the first encrypted data to at least one other computing device over a network;
receive a second encryption key in response to the first request; and
encrypt second data using the second encryption key to generate second encrypted data.

14. The system of claim 8, wherein, to detect the state of the vehicular traffic in the first area encompassing the first location of the vehicle comprises, the processing device is to send a second request comprising the first location of the vehicle to the remote computing device to retrieve the vehicular traffic in the first area.

15. A non-transitory computer-readable storage medium including instructions that, when executed by a processing device, cause the processing device to:
detect a first location of a vehicle, the vehicle comprising an encryption key used by a vehicle to encrypt data;
detect a state of vehicular traffic in a first area encompassing the first location of the vehicle; and
send, by the processing device, a first request to a remote computing device to update the encryption key, wherein the first request is sent based at least in part on the state of the vehicular traffic in the first area.

16. The non-transitory computer-readable storage medium of claim 15, wherein the processing device is further to:
update a time period based at least in part on the state of the vehicular traffic in the first area; and
send a second request to update the encryption key responsive to an expiration of the time period.

17. The non-transitory computer-readable storage medium of claim 15, wherein, to detect the state of the vehicular traffic in the first area encompassing the first location of the vehicle, the processing device is to perform at least one of determining a number of other vehicles within the first area or comparing a current speed of the vehicle to a posted speed of a route upon which the vehicle is traveling.

18. The non-transitory computer-readable storage medium of claim 15, wherein the processing device is further to:
detect a route along which the vehicle is traveling;
detect a state of vehicular traffic in a second area encompassing the route along which the vehicle is traveling; and
send a second request to the remote computing device to update the encryption key, wherein the second request is sent based at least in part on the state of the vehicular traffic in the second area.

19. The non-transitory computer-readable storage medium of claim 15, wherein the processing device is further to:
encrypt first data using a first encryption key to generate first encrypted data;
send the first encrypted data to at least one other computing device over a network;
receive a second encryption key in response to the first request; and
encrypt second data using the second encryption key to generate second encrypted data.

20. The non-transitory computer-readable storage medium of claim 15, wherein, to detect the state of the vehicular traffic in the first area encompassing the first location of the vehicle comprises, the processing device is to send a second request comprising the first location of the vehicle to the remote computing device to retrieve the vehicular traffic in the first area.
